(19) United States
(12) Patent Application Publication
(10) Pub. No.: US 2006/0145938 A1
(43) Pub. Date: Jul. 6, 2006

(54) Indoor antenna

(75) Inventor: Cheng-Si Wang, Hua Tan Hsiang (TW)

Correspondence Address: DELLETT & WALTERS, P. O. BOX 82788, PORTLAND, OR, 97282-0788, US

(73) Assignee: TRANS ELECTRIC CO.,LTD.

(21) Appl. No.: 11/029,127

(22) Filed: Jan. 3, 2005

(51) Int. Cl. H01Q 1/12

(52) U.S. Cl. 343/878

(57) ABSTRACT

An indoor antenna includes a receiving plate and a pivoting leg. The pivoting leg is composed of a supporting rod and an attachment securely yet rotatably connected to a rear side of the receiving plate. The supporting rod is pivotally connected to the attachment so that after rotatable movement of the receiving plate, the supporting rod is still able to stand the receiving plate.

### BACKGROUND OF THE INVENTION

1. Field of the Invention

The present invention relates to an indoor antenna, and more particularly to an indoor antenna which is able to clearly receive vertical and horizontal signals.

2. Description of Related Art

A conventional indoor antenna has a base and a receiving disk supported by the base. The receiving disk is firmly connected to the base such that this kind of indoor antenna is able to receive only the vertical signals or the horizontal signals. In order to overcome the shortcoming of the existing antenna, users turn the indoor antenna 90 degrees to cope with the signal pattern change. However, reversing the indoor antenna to receive different signal patterns is unpractical and not a solution to permanently solve the existing problems. Besides, when the dimension of the indoor antenna is huge, it is almost impossible to reverse the indoor antenna.

To overcome the shortcomings, the present invention tends to provide an improved indoor antenna to mitigate the aforementioned problems.

### SUMMARY OF THE INVENTION

The primary objective of the present invention is to provide an indoor antenna to enable the indoor antenna to clearly receive vertical and horizontal signals respectively.

In order to accomplish the objective, the indoor antenna of the present invention includes a pivoting leg mounted on a rear side of a receiving plate to not only support the receiving plate but also to allow the receiving plate to pivot relative to the pivoting leg so that the indoor antenna is easily adjusted for receiving different signal patterns.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the indoor antenna of the present invention;

FIG. 2 is a side plan view showing a side of the indoor antenna of the present invention;

FIG. 3 is a schematic view showing that a decorator is around a periphery of the frame of the indoor antenna of the present invention; and

FIG. 4 is a schematic view showing the application of the pivoting leg to allow the receiving plate to pivot to cope with signal pattern changes.

### DETAILED DESCRIPTION OF THE PREFERRED EMBODIMENT

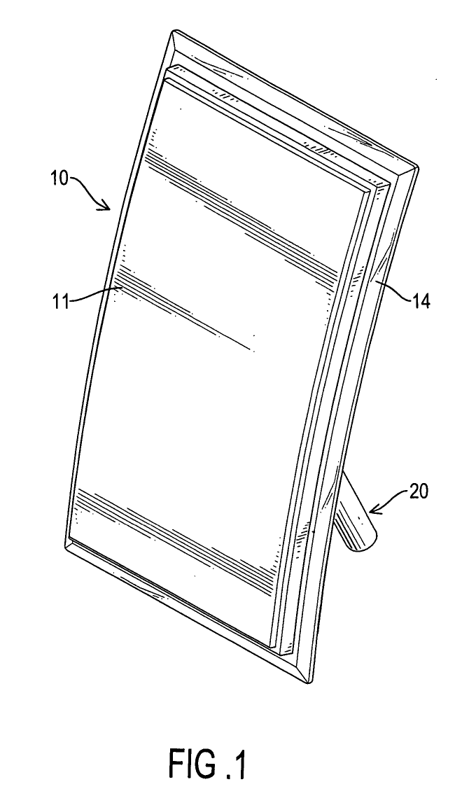

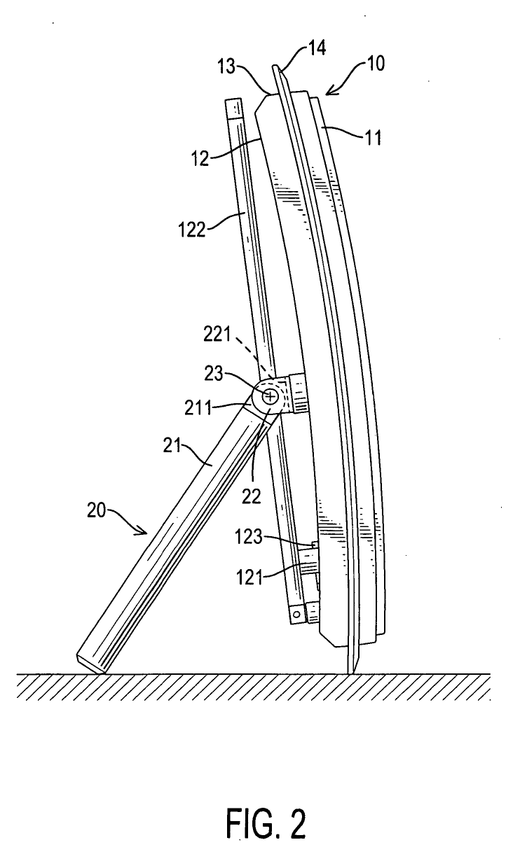

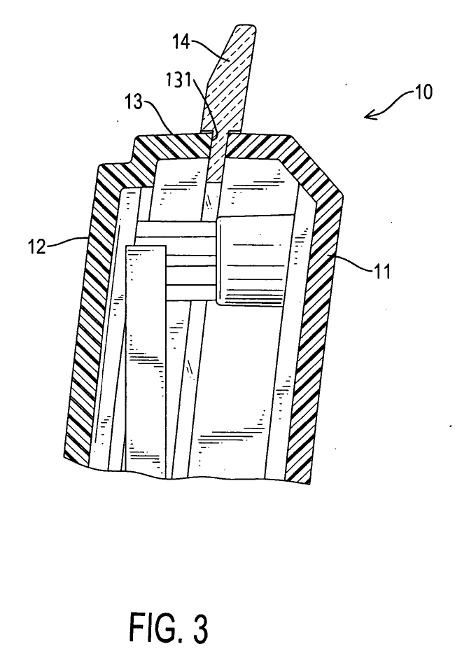

With reference to FIGS. 1 and 2, it is noted that the indoor antenna in accordance with the present invention includes a receiving plate (10) having a front side (11) and a rear side (12) and a pivoting leg (20) securely attached to the rear side (12). A side face (13) sandwiched between the front side (11) and, as shown in FIG. 3, the rear side (12) is provided with a gap (131) to receive therein a decorator (14) so as to increase the overall appearance of the receiving plate (10). The rear side (12) of the receiving plate (10) further has a coaxial cable connector (121) formed thereon, an analog antenna (122) securely connected to the coaxial cable connector (121) and a power socket (123) defined therein. The user is able to optionally mount the analog antenna (122) to allow the receiving plate (10) to receive both digital and analog signals.

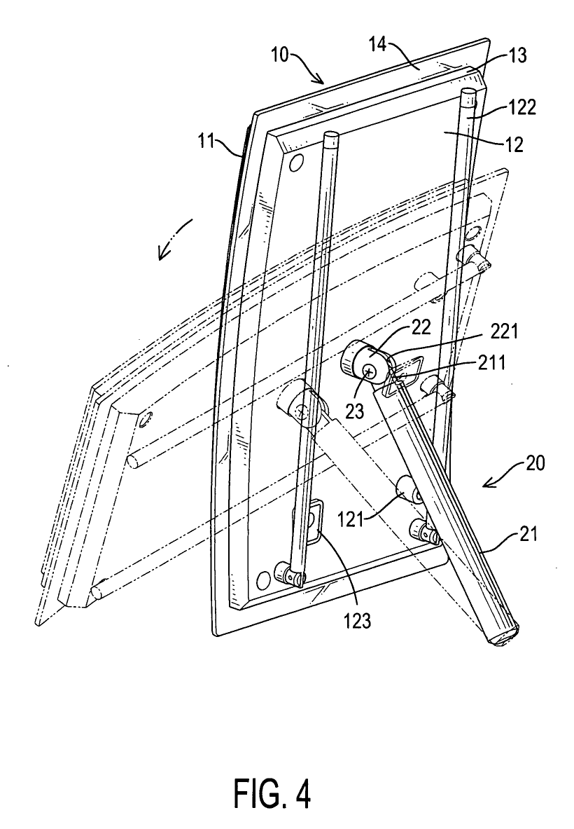

With reference to FIG. 4, the pivoting leg (20) includes a supporting rod (21) and an attachment (22) securely and rotatably connected to the rear side (12) of the receiving plate (10). The attachment (22) has a cutout (221) centrally defined in an outer face thereof to receive therein a flat end (211) of the supporting rod (21). After the flat end (211) of the supporting rod (21) is received in the cutout (221), a screw (23) is applied to secure engagement of the flat end (211) with the attachment (22).

After the indoor antenna of the present invention is assembled, it is noted that because the attachment (22) is rotatable relative to the receiving plate (10) and the supporting rod (21) is pivotable relative to the attachment (22), the user is able to rotate the receiving plate (10) and still having the supporting rod (21) to stand the receiving plate (10) regardless of the angle of the receiving plate (10). Therefore, the user is able to easily change the receiving plate angle to deal with signal pattern change to allow the indoor antenna of the present invention to clearly receive different signals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An indoor antenna comprising:
a receiving plate having a front side, a rear side and a side face sandwiched between the front side and the rear side, the rear side having a coaxial cable connector formed on the rear side and a power socket defined in the rear side; and
a pivoting leg having an attachment rotatably connected to the rear side and a supporting rod pivotally connected to the attachment to stand the receiving plate.

2. The indoor antenna as claimed in claim 1, wherein the attachment has a cutout defined in an outer face thereof to pivotally receive therein a flat end formed on the supporting rod such that the supporting rod is pivotable relative to the attachment.

3. The indoor antenna as claimed in claim 2, wherein an analog antenna is connected to the coaxial cable connector for receiving analog signals.

4. The indoor antenna as claimed in claim 3, wherein the side face has a gap defined therein to receive a decorator to enhance an overall appearance of the receiving plate.
